(19) United States
(12) Patent Application Publication
(10) Pub. No.: US 2025/0289758 A1
(43) Pub. Date: Sep. 18, 2025

(54) Paving Asphalt Binder

(71) Applicant: Russell Standard Corp., Pittsburgh, PA (US)

(72) Inventors: Brian Cancio, Grove City, PA (US); Lucas Greenawalt, New Castle, PA (US); Tyler Ogle, Austintown, OH (US)

(21) Appl. No.: 19/082,923

(22) Filed: Mar. 18, 2025

Related U.S. Application Data
(60) Provisional application No. 63/566,497, filed on Mar. 18, 2024.

(51) Int. Cl. C04B 26/26; C04B 24/12; C04B 24/26; C04B 24/28

(52) U.S. Cl. CPC C04B 26/26; C04B 24/125; C04B 24/26; C04B 24/283; C04B 24/287

(57) ABSTRACT

An asphalt binder includes asphalt, an isocyanate asphalt modifier, one or more of a block styrene butadiene or styrene butadiene styrene polymer, an adhesion promotor comprising one or more of aliphatic polyamide, polyethylene polyamine, and aliphatic polyol, and a fuel resistant polymer resin derived from polyethylene terephthalate. A method for making an asphalt binder is also provided.

### CROSS-REFERENCE TO RELATED APPLICATIONS

This application claims priority to U.S. Provisional Application No. 63/566,497, filed Mar. 18, 2024, the disclosure of which is incorporated by reference in its entirety.

### BACKGROUND OF THE INVENTION

The present disclosure relates generally to materials for use in paving and road construction.

Many paved roads are subjected to high traffic loads and varying climatic conditions, as well as exposure to fuel from vehicles. The paving materials may be compromised by exposure to such conditions, and may in turn oxidize, leading to the development of cracks in the paved road. Replacing the paving material first requires removal of the cracked, damaged, or otherwise inadequate paving material through grinding or stripping down to the base layer, which is both time consuming and costly.

Accordingly, those in skilled in the art continue research and development in the field of asphalt materials.

### SUMMARY OF THE INVENTION

Disclosed are asphalt binders.

In one example, the asphalt binder includes asphalt, an isocyanate asphalt modifier, one or more of a block styrene butadiene or styrene butadiene styrene polymer, an adhesion promotor comprising one or more of aliphatic polyamide, polyethylene polyamine, and aliphatic polyol, and a fuel resistant polymer resin derived from polyethylene terephthalate.

The asphalt binder may include 0.1 weight percent (wt. %) to 5 wt. % isocyanate asphalt modifier, based on the total weight of the asphalt.

The adhesion promotor may include aliphatic polyamide, polyethylene polyamine, or aliphatic polyol.

Also disclosed is a method for making an asphalt binder.

In one example, the method includes mixing asphalt, an isocyanate asphalt modifier, one or more of a block styrene butadiene or styrene butadiene styrene polymer, an adhesion promotor comprising one or more of aliphatic polyamide, polyethylene polyamine, and aliphatic polyol, and a fuel resistant polymer resin derived from polyethylene terephthalate at a temperature of about 370° F. to about 410° F. to yield a mixed composition and compacting the mixed composition to a compaction of about 95% at a temperature of about 350° F. to about 390° F.

Other examples will become apparent from the following detailed description and the appended claims.

### DETAILED DESCRIPTION

The following description is merely exemplary in nature and is in no way intended to limit the invention, its application, or uses. While the description is designed to permit one of ordinary skill in the art to make and use the invention, and specific examples are provided to that end, they should in no way be considered limiting. It will be apparent to one of ordinary skill in the art that various modifications to the following will fall within the scope of the appended claims. The present invention should not be considered limited to the presently disclosed embodiments, whether provided in the examples or elsewhere herein.

The use of numerical values in the various ranges specified in this application, unless expressly indicated otherwise, are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of these ranges is intended as a continuous range including every value between the minimum and maximum values. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. For definitions provided herein, those definitions refer to word forms, cognates and grammatical variants of those words or phrases.

Disclosed here in asphalt binders. As used herein, the term “asphalt” refers to any asphaltic-based paving material that can be utilized to construct and repair roads. Such materials include asphalt, asphalt binders, asphalt cements, asphalt-based cements, asphalt concrete, cut-back asphalts, emulsified asphalts, modified asphalts, bituminous material, bitumen, and the like. One of ordinary skill in the art will understand that the asphalt emulsion disclosed may be used as an adhesive to bond together layers of any asphaltic material.

Asphalt has various properties, including penetration grading, viscosity grading, and performance grading. Penetration grading refers to depth into a section of asphaltic material that a needle with 100 grams of weight thereon will penetrate when applied to the material for 5 seconds at an ambient temperature of 25 degrees Celsius (C) (77 degrees Fahrenheit). The penetration grading is measured in tenths of a millimeter (dmm). Thus, an asphalt having a penetration grading of 50 dmm is one in which a 100 gram weight penetrates the material to a depth of 5 mm after 5 seconds at an ambient temperature of 25° C. Penetration gradings may be tested according to AASHTO T-49 standard, developed by the American Society for Testing and Materials (ASTM), and promulgated by the American Association of State Highway and Transportation Officials. A non-limiting example of an asphalt is a bitumen asphalt having a penetration rating between 40 and 60.

The disclosed asphalt binder may be characterized as a highly fuel resistant pavement preservation & paving asphalt binder. In one example, the disclosed asphalt binder includes an asphalt, an isocyanate modifier, a block styrene butadiene or styrene butadiene styrene polymer, an anti-strip/adhesion promotion chemical containing aliphatic polyamides, polyethylene polyamines and/or aliphatic polyols, and a fuel resistant polymer resin derived from polyethylene terephthalate.

When the above is combined at the optimum ratios as disclosed herein, the resulting material produces an easier to handle, higher performance fuel resistant asphalt binder compared to what is readily available on the market. The disclosed asphalt binder achieves lower viscosity, superior adhesion, and less polymer degradation during applications due to lower pumping, spraying, mixing, and compaction temperatures.

Asphalt is performance graded based upon climate, referencing a high pavement surface temperature and low pavement service temperature. To determine the high pavement surface temperature of the asphalt, an average of a 7 day maximum pavement temperature is used. As thermal cracking can occur as a result of one cold night, the low pavement service temperature is the minimum pavement temperature that is likely to be experienced in a low temperature climate.

Non-limiting examples of suitable asphalts include an asphalt having an average 7 day maximum pavement temperature of 70° C. and a minimum pavement temperature of −22° C. (performance grade (PG) 70-22), an asphalt having an average 7 day maximum pavement temperature of 64° C. and a minimum pavement temperature of −22° C. (performance grade (PG) 64-22), an asphalt having an average 7 day maximum pavement temperature of 58° C. and a minimum pavement temperature of −28° C. (PG 58-28), an asphalt having an average 7 day maximum pavement temperature of 58° C. and a minimum pavement temperature of −22° C. (PG 58-22), an asphalt having an average 7 day maximum pavement temperature of 52° C. and a minimum pavement temperature of −28° C. (PG 52-28), an asphalt having an average 7 day maximum pavement temperature of 52° C. and a minimum pavement temperature of −22° C. (PG 52-22), an asphalt having an average 7 day maximum pavement temperature of 52° C. and a minimum pavement temperature of −34° C. (PG 52-34), an asphalt having an average 7 day maximum pavement temperature of 58° C. and a minimum pavement temperature of −34° C. (PG 58-34), or combinations thereof.

In one non-limiting example, the asphalt comprises PG 70-22, PG 64-22, PG 58-28, PG 52-34, PG 52-28, or combinations thereof. In another non-limiting example, the asphalt is PG 64-22, PG 58-28, PG 52-28, or combinations thereof. In another non-limiting example, the asphalt comprises PG 62-44, PG 58-28, or combinations thereof. In another non-limiting example, the asphalt comprises PG 52-34, PG 52-28, or combinations thereof.

Performance grading may be tested according to AASHTO M-320 standard or ASTM D6373-16 standard (or prior equivalent version). One of ordinary skill in the art will understand that asphalt having a similar viscosity grading or penetration grading as the performance graded asphalt may be used as a suitable asphalt.

In one example, the disclosed asphalt binder includes any of the above-mentioned compositions of asphalt at an amount of about 80 wt. % to about 95 wt. % asphalt, based on the total weight of the asphalt binder. In another example, the asphalt binder includes about 85 wt. % to about 90 wt. % asphalt, based on the total weight of the asphalt binder.

The asphalt binder further includes an isocyanate asphalt modifier to enhance binder performance and durability. The isocyanate modifier is a material having at least one isocyanate group that interacts physically and/or chemically with asphalt to form an isocyanate-modified asphalt. As used herein, an isocyanate group has the following structure:

-----N═C═O

A non-limiting commercial example of a suitable isocyanate modifier is B2Last® (BASF, Ludwigshafen, Germany).

In one example, the asphalt binder includes about 0.1 wt. % to about 5 wt. % isocyanate asphalt modifier, based on the total weight of asphalt. In another example, the asphalt binder includes about 0.5 wt. % to about 5 wt. % isocyanate asphalt modifier, based on the total weight of asphalt. In yet another example, the asphalt binder includes about 1 wt. % to about 5 wt. % isocyanate asphalt modifier, based on the total weight of asphalt.

The asphalt binder may alternatively include a thermosetting polymer modifier to enhance binder performance of durability. For example, the thermosetting polymer modifier may be ethylene-vinyl acetate (EVA). Suitable thermosetting polymer modifiers may be those commercially available under the Elvaloy family of products (DOW, Midland, Michigan).

The asphalt binder further includes one or more of a block styrene butadiene or styrene butadiene styrene polymer. In one example, the asphalt binder includes about 1 wt. % to about 8 wt. % styrene butadiene styrene polymer, based on the total weight of the asphalt binder. In another example, the asphalt binder includes about 2 wt. % to about 7 wt. % styrene butadiene styrene polymer, based on the total weight of the asphalt binder. In another example, the asphalt binder includes about 1 wt. % to 8 wt. % block styrene butadiene, based on the total weight of the asphalt binder. In yet another example, the asphalt binder includes about 2 wt. % to about 7 wt. % block styrene butadiene, based on the total weight of the asphalt binder.

In one example, the disclosed asphalt binder includes an adhesion promotor. The adhesion promoter may include one or more of aliphatic polyamide, polyethylene polyamine, and aliphatic polyol.

As used herein, “aliphatic” and related terms (such as “aliphatic group”) means non-aromatic hydrocarbon groups that include at least one carbon atom. Examples of aliphatic groups include, but are not limited to alkyl groups, alkenyl groups, and alkynyl groups.

As used herein, a “polyamide” is a compound that includes repeating units that are linked by an amide bond. For example, an aliphatic polyamide may include the following structure:

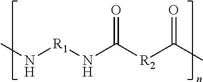

where R₁ and R₂ are the same or different aliphatic groups and n is an integer that is greater than or equal to 2.

As used herein, a “polyamine” is a compound that has greater than or equal to two amine groups. A polyethylene polyamine may include the following structure:

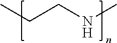

where n is an integer that is greater than or equal to 2.

As used herein, a “polyol” is a compound having greater than or equal to 2 hydroxyl (—OH) groups. For example, a polyol containing two, three, and four hydroxyl groups are diols, triols, and tetrols, respectively.

In one example, the asphalt binder includes about 0.5 wt. % to about 5.0 wt. % adhesion promotor, based on the total weight of the asphalt binder. In another example, the asphalt binder includes about 1 wt. % to about 5.0 wt. % adhesion promotor, based on the total weight of the asphalt binder. In yet another example, the asphalt binder includes about 1.5 wt. % to about 5.0 wt. % adhesion promotor, based on the total weight of the asphalt binder.

The adhesion promoter may be any composition needed for the desired material properties. In one example, the adhesion promoter includes aliphatic polyamide. An example of an aliphatic polyamide includes PC 1779 available from Ingevity. In another example, the adhesion promoter includes polyethylene polyamine. Examples of polyethylene polyamines include, but are not limited to: Indulin QTS (Ingevity), Indulin MQ3 (Ingevity), and Asfier N480L (Kao Corporation). In yet another example, the adhesion promoter includes aliphatic polyol. Examples of aliphatic polyols include, but are not limited to: Indulin XD-70 (Ingevity) and Redicote E-47 (Nouryon). In one or more examples, the disclosed asphalt binder includes a fuel resistant polymer resin. The fuel resistant polymer resin may be derived from polyethylene terephthalate. In one example, the asphalt binder includes about 0.5 wt. % to about 4 wt. % fuel resistant polymer resin, based on the total weight of the asphalt binder. In another example, the asphalt binder includes about 1 wt. % to about 4 wt. % fuel resistant polymer resin, based on the total weight of the asphalt binder. In yet another example, the asphalt binder includes about 1.5 wt. % to about 4 wt. % fuel resistant polymer resin, based on the total weight of the asphalt binder.

The disclosed asphalt binder may further be characterized by its material properties. For example, the asphalt binder may be characterized by its viscosity. In one example, the asphalt binder has a viscosity of about 300 centipoise (cP) to about 700 cP at a temperature of about 325° F. (162.8° C.). In another example, the asphalt binder has a viscosity of about 350 cP to about 600 cP at a temperature of about 325° F. (162.8° C.). In yet another example, the asphalt binder has a viscosity of about 300 cP to about 500 cP at a temperature of about 325° F. (162.8° C.).

In one or more examples, the disclosed asphalt binder may include a binder for a hot applied chip scal if sprayed at about 350° F. (176.7° C.) to about 400° F. (204.4° C.) that coats and adheres to aggregates placed atop the binder shortly thereafter. The binder may be characterized by its strong adhesion properties with all acceptable aggregate typically used in chip scal operations complying with the International Slurry Surfacing Association (ISSA) best practices. Additionally, the binder may be used in a standard hot mix plant without the need for modifications if running at a higher temperatures per the below mixing and compaction temperatures to produce an asphalt concrete suitable for paving of surface courses or similar pavements.

Also disclosed is a method for making an asphalt binder as described herein. The method may yield an asphalt binder characterized in that it passes the Fuel Resistance Requirement of FAA P-601 Table 1 Section 601-3.3.

In one example, the method includes mixing asphalt, an isocyanate asphalt modifier, onc or more of a block styrene butadiene or styrene butadiene styrene polymer, an adhesion promotor comprising one or more of aliphatic polyamide, polyethylene polyamine, and aliphatic polyol, and a fuel resistant polymer resin derived from polyethylene terephthalate at a temperature of about 370° F. (187.8° C.) to about 410° F. (210° C.) to yield a mixed composition.

In one example, the asphalt of the method is added to the mixed composition at an amount of about 80 wt. % to about 95 wt. % asphalt, based on the total weight of the asphalt binder. In another example, the asphalt of the method is added to the mixed composition at an amount of about 85 wt. % to about 90 wt. % asphalt, based on the total weight of the asphalt binder.

The isocyanate asphalt modifier of the method is added to the mixed composition to enhance binder performance and durability. The isocyanate asphalt modifier may be any of the isocyanate asphalt modifiers described herein.

In one example, the asphalt binder of the method includes about 0.1 wt. % to about 5 wt. % isocyanate asphalt modifier, based on the total weight of the asphalt. In another example, the asphalt binder includes about 0.5 wt. % to about 5 wt. % isocyanate asphalt modifier, based on the total weight of the asphalt. In yet another example, the asphalt binder of the method includes about 1 wt. % to about 5 wt. % isocyanate asphalt modifier, based on the total weight of the asphalt.

The asphalt binder of the method may alternatively include a thermosetting polymer modifier to enhance binder performance of durability. The thermosetting polymer modifier may be any of the thermosetting polymer modifiers described herein.

In one example, the asphalt binder of the method includes about 1 wt. % to about 8 wt. % styrene butadiene styrene polymer, based on the total weight of the asphalt binder. In another example, the asphalt binder of the method includes about 2 wt. % to about 7 wt. % styrene butadiene styrene polymer, based on the total weight of the asphalt binder. In another example, the asphalt binder of the method includes about 1 wt. % to 8 wt. % block styrene butadiene, based on the total weight of the asphalt binder. In yet another example, the asphalt binder of the method includes about 2 wt. % to about 7 wt. % block styrene butadiene, based on the total weight of the asphalt binder.

In one example, the asphalt binder of the method includes about 0.5 wt. % to about 5.0 wt. % adhesion promotor, based on the total weight of the asphalt binder. In another example, the asphalt binder of the method includes about 1 wt. % to about 5.0 wt. % adhesion promotor, based on the total weight of the asphalt binder. In yet another example, the asphalt binder of the method includes about 1.5 wt. % to about 5.0 wt. % adhesion promotor, based on the total weight of the asphalt binder.

The adhesion promoter of the method may be any composition needed for the desired material properties. In one example, the adhesion promoter of the method includes aliphatic polyamide. In another example, the adhesion promoter of the method includes polyethylene polyamine. In yet another example, the adhesion promoter of the method includes aliphatic polyol.

The fuel resistant polymer resin of the method may be derived from polyethylene terephthalate. In one example, the asphalt binder of the method includes about 0.5 wt. % to about 4 wt. % fuel resistant polymer resin, based on the total weight of the asphalt binder. In another example, the asphalt binder of the method includes about 1 wt. % to about 4 wt. % fuel resistant polymer resin, based on the total weight of the asphalt binder. In yet another example, the asphalt binder of the method includes about 1.5 wt. % to about 4 wt. % fuel resistant polymer resin, based on the total weight of the asphalt binder.

The disclosed asphalt binder of the method may further be characterized by its material properties. For example, the asphalt binder may be characterized by its viscosity. In one example, the asphalt binder of the method has a viscosity of about 300 cP to about 700 cP at a temperature of about 325° F. (162.8° C.). In another example, the asphalt binder of the method has a viscosity of about 350 cP to about 600 cP at a temperature of about 325° F. (162.8° C.). In yet another example, the asphalt binder has a viscosity of about 300 cP to about 500 cP at a temperature of about 325° F. (162.8° C.). The inclusion of the isocyanate asphalt modifier and the one or more of a block styrene butadiene or styrene butadiene styrene polymer in the asphalt binder create an improved performance at a lower viscosity.

The viscosity of the asphalt binder may be further adjusted by adding a viscosity modifier to the asphalt binder. For example, a viscosity modifier may be added to further lower the viscosity of the asphalt binder and to improve the handling of the asphalt binder. For example, the viscosity modifier may be Anova 1006 (Cargill Bioindustrial).

The method further includes compacting the mixed composition to a compaction of about 95% at a temperature of about 350° F. (176.7° C.) to about 390° F. (198.9° C.).

In one or more examples, the method may further include pumping the mixed composition and spraying the mixed composition. In one example, the pumping is performed at a temperature of about 350° F. (176.7° C.) to about 425° F. (218.3° C.). In another example, the spraying is performed at a temperature of about 350° F. (176.7° C.) to about 425° F. (218.3° C.).

This disclosure is further described in the following numbered clauses:

Clause 1: An asphalt binder comprising: asphalt; an isocyanate asphalt modifier; one or more of a block styrene butadiene or styrene butadiene styrene polymer; an adhesion promotor comprising one or more of aliphatic polyamide, polyethylene polyamine, and aliphatic polyol; and a fuel resistant polymer resin derived from polyethylene terephthalate.

Clause 2: The asphalt binder of clause 1, comprising 80 wt. % to 95 wt. % asphalt, based on the total weight of the asphalt binder.

Clause 3: The asphalt binder of clause 1, comprising 0.1 wt. % to 5 wt. % isocyanate asphalt modifier, based on the total weight of the asphalt.

Clause 4: The asphalt binder of clause 1, comprising 1 wt. % to 8 wt. % block styrene butadiene, based on the total weight of the asphalt binder.

Clause 5: The asphalt binder of clause 1, comprising 1 wt. % to 8 wt. % styrene butadiene styrene polymer, based on the total weight of the asphalt binder.

Clause 6: The asphalt binder of clause 1, comprising 0.5 wt. % to 5.0 wt. % adhesion promotor, based on the total weight of the asphalt binder.

Clause 7: The asphalt binder of clause 1, wherein the adhesion promotor comprises aliphatic polyamide.

Clause 8: The asphalt binder of clause 1, wherein the adhesion promotor comprises polyethylene polyamine.

Clause 9: The asphalt binder of clause 1, wherein the adhesion promotor comprises aliphatic polyol.

Clause 10: The asphalt binder of clause 1, comprising 0.5 wt. % to 4 wt. % fuel resistant polymer resin, based on the total weight of the asphalt binder.

Clause 11: The asphalt binder of clause 1, having viscosity of about 300 cP to about 700 cP at a temperature of approximately 325° F.

Clause 12: A method for making an asphalt binder comprising: mixing asphalt, an isocyanate asphalt modifier, one or more of a block styrene butadiene or styrene butadiene styrene polymer, an adhesion promotor comprising one or more of aliphatic polyamide, polyethylene polyamine, aliphatic polyol, and a fuel resistant polymer resin derived from polyethylene terephthalate at a temperature of about 370° F. to about 410° F. to yield a mixed composition; and compacting the mixed composition to a compaction of about 95% at a temperature of about 350° F. to about 390° F.

Clause 13. The method of clause 12, further comprising spraying the mixed composition.

Clause 14. The method of clause 12, further comprising pumping the mixed composition.

Clause 15. The method of clause 12, further comprising applying a layer of pre-coated aggregate chips to the mixed composition.

It will be readily appreciated by those skilled in the art that modifications may be made to the disclosure without departing from the concepts disclosed in the foregoing description. Accordingly, the particular examples described in detail herein are illustrative only and are not limiting to the scope of the disclosure, which is to be given the full breadth of the appended claims and any and all equivalents thereof.

What is claimed is:

1. An asphalt binder comprising:
asphalt;
an isocyanate asphalt modifier;
one or more of a block styrene butadiene or styrene butadiene styrene polymer;
an adhesion promotor comprising one or more of aliphatic polyamide, polyethylene polyamine, and aliphatic polyol; and
a fuel resistant polymer resin derived from polyethylene terephthalate.

2. The asphalt binder of claim 1, comprising 80 weight percent (wt. %) to 95 wt. % asphalt.

3. The asphalt binder of claim 1, comprising 0.1 wt. % to 5 wt. % isocyanate asphalt modifier, based on the total weight of the asphalt.

4. The asphalt binder of claim 1, comprising 1 wt. % to 8 wt. % block styrene butadiene, based on the total weight of the asphalt binder.

5. The asphalt binder of claim 1, comprising 1 wt. % to 8 wt. % styrene butadiene styrene polymer, based on the total weight of the asphalt binder.

6. The asphalt binder of claim 1, comprising 0.5 wt. % to 5.0 wt. % adhesion promotor, based on the total weight of the asphalt binder.

7. The asphalt binder of claim 1, wherein the adhesion promotor comprises aliphatic polyamide.

8. The asphalt binder of claim 1, wherein the adhesion promotor comprises polyethylene polyamine.

9. The asphalt binder of claim 1, wherein the adhesion promotor comprises aliphatic polyol.

10. The asphalt binder of claim 1, comprising 0.5 wt. % to 4 wt. % fuel resistant polymer resin, based on the total weight of the asphalt binder.

11. The asphalt binder of claim 1, having viscosity of about 300 cP to about 700 cP at a temperature of approximately 325° F.

12. A method for making an asphalt binder comprising:
mixing asphalt, an isocyanate asphalt modifier, one or more of a block styrene butadiene or styrene butadiene styrene polymer, an adhesion promotor comprising one or more of aliphatic polyamide, polyethylene polyamine, aliphatic polyol, and a fuel resistant polymer resin derived from polyethylene terephthalate at a temperature of about 370° F. to about 410° F. to yield a mixed composition; and
compacting the mixed composition to a compaction of about 95% at a temperature of about 350° F. to about 390° F.

13. The method of claim 12, further comprising spraying the mixed composition.

14. The method of claim 12, further comprising pumping the mixed composition.

15. The method of claim 12, further comprising applying a layer of pre-coated aggregate chips to the mixed composition.
